(19) United States
(12) Patent Application Publication
(10) Pub. No.: US 2015/0170817 A1
(43) Pub. Date: Jun. 18, 2015

(54) REACTOR APPARATUS

(71) Applicant: PANASONIC CORPORATION, Osaka (JP)

(72) Inventors: Atsushi YAMASHIMA, Kanagawa (JP); Yuuji YAMAGUCHI, Kanagawa (JP); Shuzo ISODA, Kanagawa (JP)

(73) Assignee: PANASONIC CORPORATION, Osaka (JP)

(21) Appl. No.: 14/388,448

(22) PCT Filed: Mar. 8, 2013
(86) PCT No.: PCT/JP2013/001484

§ 371 Date: Sep. 26, 2014

(30) Foreign Application Priority Data
Mar. 26, 2012 (JP) 2012-070024

(51) Int. Cl. H01F 27/00; H01F 27/06; H01F 27/02

(52) U.S. Cl. CPC H01F 27/008; H01F 27/025; H01F 27/06

(57) ABSTRACT

This reactor apparatus is capable of having both the excellent heat dissipating characteristics and insulating characteristics. The heat dissipating characteristics of the reactor apparatus are improved by having a metal plate (300), which has high heat dissipating characteristics, in direct contact with the whole surface of the bottom surface portion (204) of a case (200), which is formed of an insulating resin, and which houses the whole coil (120) of a reactor. A heat dissipating adhesive is applied to and hardened between the bottom surface portion (204) and the metal plate (300). Furthermore, the metal plate (300) is fixed to the bottom surface portion (204) by means of braces (400).

### TECHNICAL FIELD

The present invention relates to a reactor apparatus including a coil.

### BACKGROUND ART

In recent years, plug-in HEVs (Hybrid Electric Vehicles) and EVs (Electric Vehicles) have been popularized. Such an EV or plug-in HEV includes an in-vehicle charging apparatus that converts AC power supplied from outside into a direct current and outputs the direct current to a storage battery of the vehicle.

The in-vehicle charging apparatus of the HEV or EV includes a reactor apparatus having a coil for an improvement in a power factor or smoothing.

A very high voltage of approximately 400 V is applied to the reactor apparatus used for an in-vehicle charger of the HEV or EV. For this reason, the temperature of the coil becomes very high due to heat generation. In this case, in order to prevent overheating of the coil in the in-vehicle charger, it is important to provide a reactor apparatus having very high heat radiation properties. Additionally, it is also important to provide reliable electric insulation properties between a metal base or a metal heat radiation member and the coil.

A known reactor apparatus including a coil is disclosed in Patent Literature (hereinafter, abbreviated as PTL) 1. PTL 1 discloses a transformer including a coil bobbin formed by winding a coil around the bobbin, and a core. A transformer body is held in an insulated protection case having several protruding portions. In this state, silicone casting resin is placed and cured in the insulated protection case so as to cover the transformer body and the projections.

### CITATION LIST

### Patent Literature

### PTL 1

Japanese Utility Model (Registration) Application No. HEI 6-44117

### SUMMARY OF INVENTION

### Technical Problem

However, the reactor apparatus in PTL 1 includes a case made of a resin material having low thermal conductivity for ensuring insulation properties, and therefore the heat radiation properties from the side and bottom surfaces is insufficient. Consequently, in order to provide both the insulation properties and the heat radiation properties of the case containing the coil, an insulating resin having high heat radiation properties may be used as a material for forming this case, and this case may be attached to a metal heat radiation member.

However, the case made of an insulating resin material having high heat radiation properties has the properties that the case is easily broken and the surface of the case easily warp during the manufacture of the reactor apparatus. Therefore, when being attached to the metal heat radiation member, there may be a situation where a sufficient heat radiation properties and insulation properties cannot be secured because of a gap between the case and the attachment surface of the metal heat radiation member generated by breakage of the case or the warpage of the surface of the case.

Moreover, in order to efficiently radiate heat generated from the coil to the exterior, it is necessary to prevent a decrease in the heat conduction efficiency from the surface of the case to the metal heat radiation member because of the warpage of the surface of this case. However, PTL 1 discloses no solution to the problem.

It is an object of the present invention to provide a reactor apparatus capable of having both heat radiation properties and insulation properties.

### Solution to Problem

A reactor apparatus according to an aspect of the present invention includes: a coil that includes an annularly wound conductor wire and that is energized to generate a magnetic flux; a case that is made of a heat radiating resin material in a cylindrical shape having a side surface portion, a bottom surface portion, and one open end, that includes a first fastening section extending outward from an outer wall of the side surface portion, and that houses the coil; a potting resin that fills a space between an inner wall of the case and the coil; a metal plate that includes a second fastening section to be fastened with the first fastening section and that is fixed so as to be in contact with a whole surface of the bottom surface portion of the case; a heat radiating adhesive that fills a gap generated between the bottom surface portion of the case and the metal plate; and a fastener that fixes the first fastening section and the second fastening section together.

### Advantageous Effects of Invention

In the present invention as described above, the bottom surface portion of the container case is made of a heat radiation resin having high thermal conductivity, and additionally, the metal plate having high heat radiation properties is brought into direct contact with the overall surface of the bottom surface portion to thereby improve the radiation properties of the reactor apparatus.

Furthermore, in the present invention, even if the bottom surface portion warps and thus generates a gap between the metal plate and the bottom surface portion when the fastening sections of the bottom surface portion of the container case and the fastening sections of the metal plate are fixed together with the fasteners, the heat conduction of the heat radiated from this bottom surface portion is efficiently conducted to the metal plate through the layer of the adhesive. More specifically, the above-mentioned effects are obtained by placing and curing the heat radiating adhesive in the gap generated between the bottom surface portion and the metal plate by the warpage. Consequently, a decrease in the heat radiation efficiency of the container case is prevented, which would otherwise occur due to incompleteness in direct contact between the whole surfaces of the bottom surface portion of the container case and the metal plate.

Additionally, the bottom surface portion of the container case made of an insulation resin material completely isolates the conductive coil of the reactor from the metal plate, and thus ensures insulation properties.

Therefore, it is possible to easily obtain the structure of stably holding the coil in the container case while ensuring the insulation between the metal plate and the conductive coil. Consequently, the manufacturing process for the above-described reactor apparatus can also be simplified significantly, so that a high production yield can be maintained.

### BRIEF DESCRIPTION OF DRAWINGS

FIG. 1 is a perspective view of a whole reactor apparatus according to an embodiment of the present invention;

FIG. 2 is an exploded view of the whole reactor apparatus in FIG. 1;

FIGS. 3A and 3B are sectional views of the whole reactor apparatus in FIG. 1; and

FIGS. 4A to 4E are five-side views of the whole reactor apparatus in FIG. 1.

### DESCRIPTION OF EMBODIMENT

(Overview of Present Embodiment)

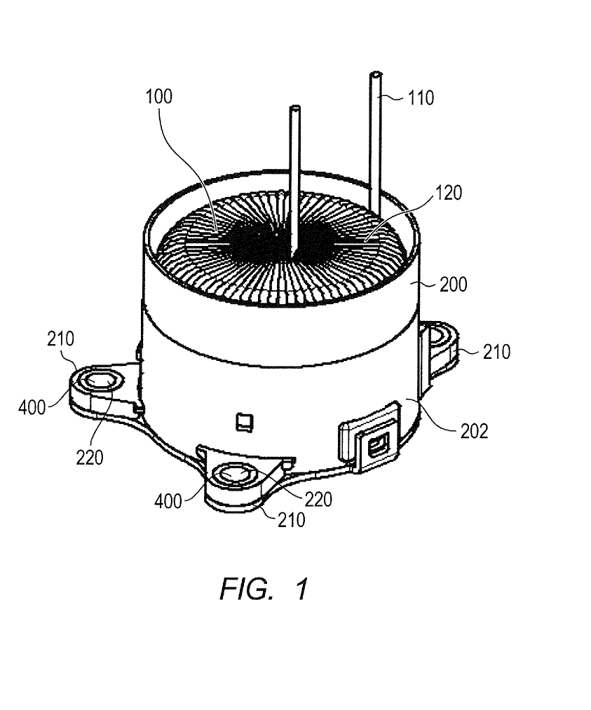

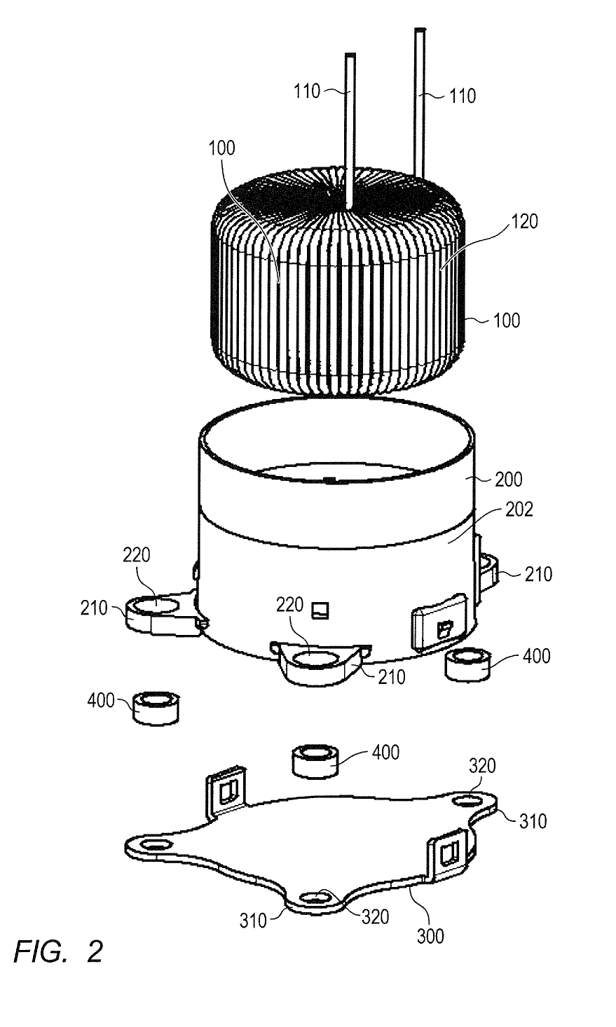

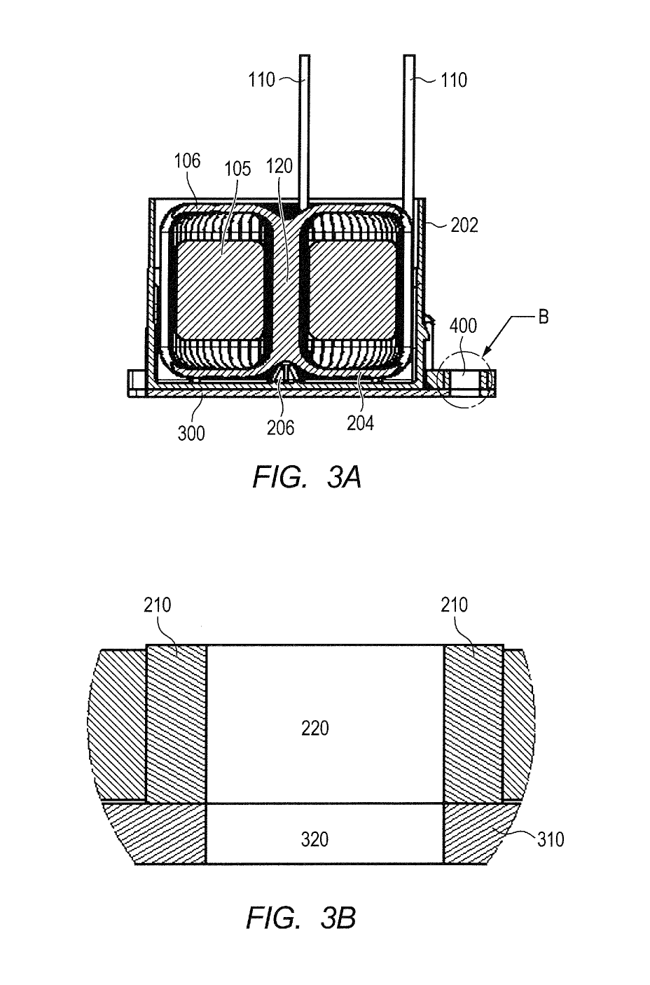

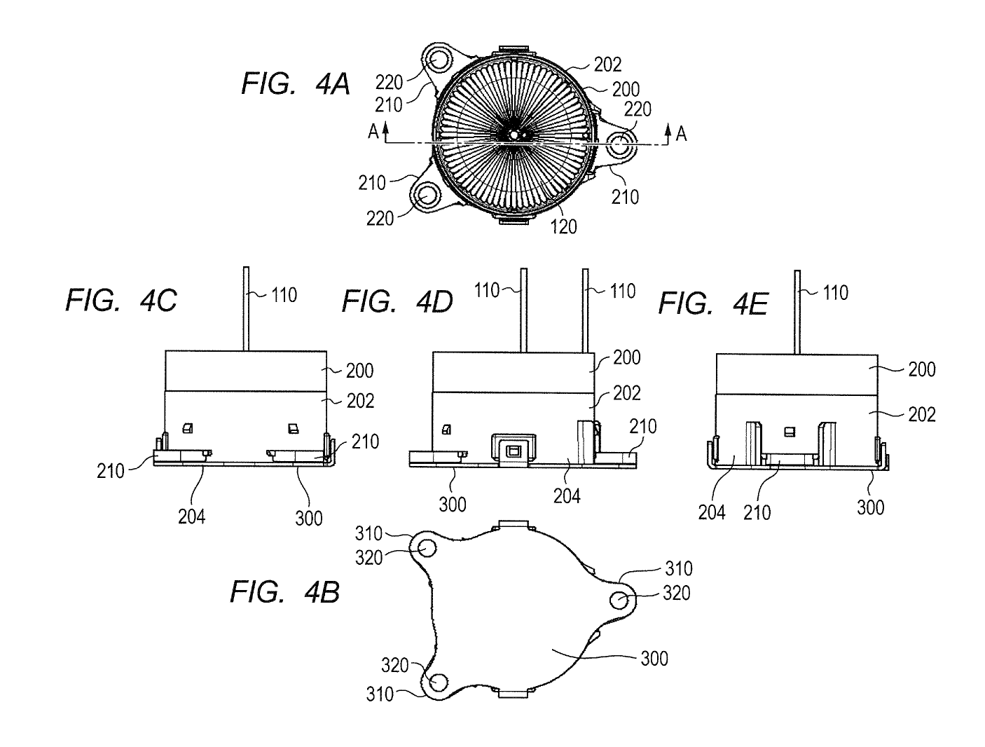

FIG. 1 is a perspective view of a whole reactor apparatus according to an embodiment of the present invention; FIG. 2 is an exploded view of the same, and FIGS. 3A and 3B are sectional views of the whole reactor apparatus in FIG. 1; and FIGS. 4A to 4E are six-side views of the whole reactor apparatus in FIG. 1. FIG. 4A is the top view; FIG. 4B is the bottom view; FIG. 4C is the front view, FIG. 4D is the right side view, and FIG. 4E is the left view.

In the present embodiment, conductive coil 120 of reactor 100 is housed and held in container case 200 made of a heat radiation resin having high thermal conductivity to thereby ensure the insulation properties between coil 120 and the exterior of container case 200. Additionally, metal plate 300, which is a highly thermal-conductive metal plate, is attached to the bottom surface of container case 200, and the insulation properties between coil 120 and metal plate 300 is maintained by bottom surface portion 204 of container case 200. Metal plate 300 is installed and fixed to a base (not illustrated) including a cooling mechanism. At this time, it is preferable that bottom surface portion 204 of resin-made container case 200 have a minimum thickness required to bear the weight of housed coil 120 and also to support coil 120, so as to allow for efficient heat conduction of heat radiated from the reactor as much as possible to metal plate 300, which is a heat radiation member. This results in both improvement of the heat radiation properties of resin-made container case 200 and achievement of reliable insulation properties between coil 120 and metal plate 300.

Furthermore, container case 200 and a reactor 100 need to be firmly fixed so as not to be separated from the base portion including metal plate 300 due to shock and vibration applied to an HEV or EV. Therefore, it is inappropriate to attach metal plate 300 to bottom surface portion 204 of container case 200 by adhesion using only a heat radiating adhesive, which readily causes separation due to light shock.

In the present embodiment, leg-like fastening sections 210 are formed so as to extend outward from the outer edge of bottom surface portion 204 of container case 200 in the horizontal direction of bottom surface portion 204, and fastening section 210 are provided with hole portions 220 for inserting collars 400 as fasteners. Fastening section 310 and hole portion 320 having the same shape are also formed in the outer edge of metal plate 300 at the vertically overlapping same positions as fastening section 210 formed in the outer edge of the bottom surface portion of container case 200. Then, a screw inserted from the opposite side to container case 200 through hole portion 320 is tightened into a screw hole provided in collar 400 inserted in hole portion 220 of fastening section 210. Thereby, bottom surface portion 204 of container case 200 is fixed to metal plate 300.

However, bottom surface portion 204 of resin-made container case 200 fixed onto metal plate 300 warps while curving with respect to the horizontal surface of metal plate 300. This warpage may generate a thin gap between bottom surface portion 204 of container case 200 and the surface of metal plate 300 and lead to an incompleteness in direct contact over the whole surface between bottom surface portion 204 of container case 200 and metal plate 300. This gap halfway prevents heat conduction of heat radiation transmitted from bottom surface portion 204 of container case 200 to metal plate 300 and causes inefficient heat radiation from container case 200. For this reason, a heat radiating adhesive having high thermal conductivity is placed and cured in this gap to efficiently transmit heat radiation from container case 200 to the base including metal plate 300 and the cooling mechanism through the layer of the placed and cured heat radiating adhesive. Accordingly, the heat radiation properties of resin-made container case 200 are further improved. Such heat radiating adhesives may be adhesives containing, for example, a silicon resin or an epoxy resin as a principal component.

(Detailed Explanation of Reactor Apparatus According to Present Embodiment)

Hereinafter, an embodiment of the present invention will be described in detail with reference to the accompanying drawings.

Reactor 100 includes coil 120 having a winding wire structure and lead wires 110 serving as terminals for connecting between coil 120 and other circuit elements.

Container case 200 is formed as a cylindrical shape having one open end. This cylindrical shape has bottom surface portion 204 and side surface portion 202. Internal space 205 for housing coil 120 in container case 200 is formed of bottom surface portion 204 and side surface portion 202. At this time, it is preferable that bottom surface portion 204 of container case 200 have a minimum thickness required to bear the weight of coil 120 and supporting coil 120 from the bottom according to the weight of coil 120.

Container case 200 includes a plurality of leg-like fastening sections 210 that extend outward from the outer edge of the bottom surface portion parallel to the horizontal surface of bottom surface portion 204. Each of fastening sections 210 includes circular hole portion 220 for inserting the fastener. Protrusive center fixing member 206 is formed at the inner wall center of bottom surface portion 204.

Container case 200 is made of a flame-resistant resin material having high heat radiation properties. A flame-resistant resin material typically refers to a resin material that can bear a high temperature of about 150 degrees, which is a rated temperature when a reactor generates heat. Examples of resin having high flame resistance include PBT+ABS−GF30 (ISO (JIS) materials indication) having a thermal conductivity of 0.3 [W/m·K] or greater. Examples of resin having both high heat radiation properties and a flame resistance include PPS (GF+MD) (ISO (JIS) materials indication) having a thermal conductivity of 3.0 [W/m·K] or greater.

Core 105 and lead wire section 106 in FIG. 3A are a core and a lead wire portion having a coil structure constituting coil 120 housed in container case 200, respectively. In FIG. 3A, the side of coil 120 housed in container case 200 contacts the inner surface of side surface portion 202 of container case 200, and the bottom surface of housed coil 120 contacts bottom surface portion 204 of container case 200.

A potting resin (not illustrated) is poured, placed and cured in a space between coil 120 housed in container case 200 and the inner wall of container case 200. An example of this potting resin is a general silicon-based or epoxy based-resin.

Metal plate 300 mutually forms a parallel surface with and vertically faces bottom surface portion 204 of container case 200 (FIG. 2). Metal plate 300 includes a plurality of leg-like fastening sections 310 that extend outward from the metal plate outer edge parallel to the plate horizontal surface, and each fastening section 310 is provided with circular hole portion 320 for inserting the fastener (FIG. 2). When bottom surface portion 204 of container case 200 is attached to metal plate 300, a pair of hole portions 220 and 320 provided in a pair of fastening sections 210 and 310, respectively, facing and vertically overlapping with each other is formed so that the hole portions have the same center positions viewed from the top of container case 200.

Bottom surface portion 204 of container case 200 and metal plate 300 are attached over the whole surface by adhesion using a heat radiating adhesive (not illustrated). Consequently, the heat radiating adhesive is placed and cured in the gap between bottom surface portion 204 of the container case and the bonding surface of metal plate 300 (FIG. 2 and FIG. 3A).

Collar 400 illustrated in FIG. 2 and FIGS. 3A and 3B is a fastener for fixing metal plate 300 onto bottom surface portion 204 of container case 200. Collar 400 is made of a general metal material, such as SPCC (cold-rolled steel sheet), which is an iron material, and has a cylindrical shape having a screw hole therethrough along the central axis. Collar 400 is inserted in hole portion 220 of fastening section 210 in shaping by molding of container case 200, and is integrated with fastening section 210. When bottom surface portion 204 of container case 200 is attached onto metal plate 300, the screw hole of collar 400 inserted in and integrated with hole portion 220 vertically overlaps with hole portion 320. When metal plate 300 is attached onto bottom surface portion 204 of container case 200, the screw hole of collar 400 inserted in hole portion 220 vertically overlaps hole portion 320 of fastening section 310 in portion B in FIG. 3A. FIG. 3B is an enlarged view of portion B in FIG. 3A and illustrates that the screw hole of collar 400 and hole portion 320 vertically overlapping with each other form a single hole penetrating through fastening section 210 and fastening section 310 in the above-described fixing.

(Detailed Explanation of Assembly Process of Reactor Apparatus According to Present Embodiment)

When container case 200 is cast using resin as a material, collar 400 is inserted in hole portion 220 of fastening section 210 formed on the outer wall of container case 200, and container case 200 and collar 400 are integrally shaped by molding. At this time, the upper end of collar 400 inserted in hole portion 220 slightly protrudes from the upper surface portion of fastening section 210.

Next, metal plate 300 is attached to bottom surface portion 204 of container case 200 by adhesion using the heat radiating adhesive so as to be directly in contact with bottom surface portion 204 of container case 200 (FIG. 2 and FIG. 3A). At this time, fastening section 310 of metal plate 300 is directly in contact with fastening section 210 of container case 200 by adhesion using the heat radiating adhesive. With reference to FIG. 3A, the bottom surface of coil 120 and attached metal plate 300 face each other in parallel via bottom surface portion 204 of container case 200, which ensure the insulation state between conductive coil 120 and metal plate 300.

At this time, the screw hole of collar 400 inserted in hole portion 220 vertically overlaps hole portion 320 of fastening section 310, and the screw hole of collar 400 is connected to hole portion 320 to form one hole penetrating through fastening section 210 and fastening section 310 (FIG. 3B).

Furthermore, in order to more firmly fix bottom surface portion 204 onto metal plate 300, a screw is inserted in hole portion 320 from the opposite side to fastening section 210 and tightened into the screw hole threaded in collar 400 inserted in fastening section 210. Accordingly, bottom surface portion 204 is fixed to metal plate 300 by collar 400 as a fastener. As described above, the material of resin-made container case 200 is readily broken. Therefore, container case 200 is joined to metal plate 300 by screwing through metal collar 400. Accordingly, the force caused by screwing is applied to a joint part between pieces of metal and is not directly applied to container case 200. This provides an advantageous effect of enabling prevention of breaking the case. Collar 400 is shaped by molding with container case 200 and is therefore fixed surely.

At this time, the heat radiating adhesive also is placed and cured in the gap between the upper end of collar 400 slightly protruding from the upper surface portion of fastening section 210 and the upper surface portion of fastening section 210.

Coil 120 in reactor 100 is inserted from above into and housed in container case 200 (FIG. 2 and FIG. 3A). At this time, center fixing member 206 that protrudes from the inner wall center of bottom surface portion 204 of container case 200 is fitted into a hole provided in the center of toroidal-shaped coil 120, and toroidal-shaped coil 120 is thereby fixed at the central position within container case 200. Then, a potting resin is poured into container case 200, placed, and cured in a space between coil 120 and the inner wall of container case 200. At this time, toroidal-shaped coil 120 is fixed to the central position within container case 200. Therefore, the gap, which is filled with a potting resin material, between coil 120 and the inner wall of container case 200 is constant over the entire periphery of coil 120.

(First Operational Effect of Present Embodiment)

From the above, in the present embodiment, bottom surface portion 204 of container case 200 is made of a heat radiating resin having high thermal conductivity, and additionally, bottom surface portion 204 described above is set to have a minimum thickness required to support the reactor weight from the bottom. Moreover, metal plate 300, which is integrated with the base portion including the cooling mechanism, and which has high heat radiation properties, is brought into direct contact over the whole surface of bottom surface portion 204. This improves the heat radiation properties of the reactor apparatus, and achieves reliable insulation properties between conductive coil 120 and metal plate 300 by interposing bottom surface portion 204 of container case 200 between conductive coil 120 and metal plate 300.

Additionally, a heat radiating adhesive having high thermal conductivity is placed and cured in the gap generated between bottom surface portion 204 and metal plate 300 to efficiently transmit heat radiation from container case 200 to the base including metal plate 300 and the cooling mechanism through the layer of the placed and cured heat radiating adhesive. This further improves the heat radiation properties of resin-made container case 200 and provides both the insulation properties and the heat radiation properties of the reactor apparatus.

(Second Operational Effect of Present Embodiment)

In the assembly process for the reactor apparatus according to the present embodiment, coil 120 is housed so as to fit into container case 200, and the metal plate is attached onto bottom surface portion 204 of container case 200 with the heat radiating adhesive. Furthermore, fastening sections 210 of container case 200 are fixed to fastening sections 310 of metal plate 300 by screw fixing sections of the pieces of metal for the screw holes provided in metal collar 400. The reactor apparatus can be manufactured only by the abovementioned processes.

Therefore, container case 200 can be prevented from cracking and breaking when the screws are tightened, unlike the case where screw holes are provided directly in fastening sections 210 of container case 200 made of a fragile material such as resin and where the screws are inserted through the screw holes from hole portions 320 of metal plate 300 are tightened.

Additionally, the above-described simple assembly process enables the structure that stably holds coil 120 within container case 200 to be readily manufactured, while ensuring insulation between metal plate 300 and conductive coil 120. As a result, the manufacturing processes for the above-described reactor apparatus can also be simplified significantly, so that a high production yield can be maintained.

(Third Operational Effect of Present Embodiment)

A reactor and a container case therefor need to be downsized as much as possible in order to be readily housed in an electric driving apparatus integrated with an in-vehicle charging apparatus of an EV or HEV. In this case, the reactor apparatus is configured according to the aspect of the above-described embodiment illustrated in FIG. 1 and FIG. 2 to thereby ensure insulation between container case 200 and coil 120 even when the downsizing is achieved. More specifically, even if container case 200 and metal plate 300 are downsized, container case 200 can stably hold coil 120 while conductive coil 120 is completely separated from metal plate 300 by bottom surface portion 204 made of resin that is an insulating material. Thereby, coil 120 can be held in an extremely narrow space inside downsized container case 200, while insulation is completely maintained between coil 120 and the exterior. Additionally, such a downsized structure having reliable insulation properties can readily be formed only by fitting coil 120 into container case 200 in the manufacturing processes for the reactor apparatus.

(Fourth Operational Effect of Present Embodiment)

The reactor apparatus according to the present invention can be implemented regardless of the shape of container case 200 or the shape of coil 120. Therefore, a reactor apparatus having high heat radiation properties and high insulation properties can be manufactured with a simple structure and a formation method using not only a spiral coil shape, but also any coil shape such as a toroidal shape.

The disclosure of Japanese Patent Application No. 2012-70024 filed on Mar. 26, 2012, including the specification, drawings and abstract is incorporated herein by reference in its entirety.

### INDUSTRIAL APPLICABILITY

The present invention can be utilized as, for example, a structure for housing and holding a reactor used as an inductance element in a motor drive circuit in an electric driving apparatus.

### REFERENCE SIGNS LIST

100 Reactor
105 Core
106 Lead wire section
110 Lead wire
120 Coil
200 Container case
202 Side surface portion
204 Bottom surface portion
206 Center fixing member
210 Fastening section
220 Hole portion
300 Metal plate
310 Fastening section
320 Hole portion
400 Collar

1. A reactor apparatus comprising:
a coil that includes an annularly wound conductor wire and that is energized to generate a magnetic flux;
a case that is made of a heat radiating resin material in a cylindrical shape having a side surface portion, a bottom surface portion, and one open end, that includes a first fastening section extending outward from an outer wall of the side surface portion, and that houses the coil;
a potting resin that fills a space between an inner wall of the case and the coil;
a metal plate that includes a second fastening section to be fastened with the first fastening section and that is fixed so as to be in contact with a whole surface of the bottom surface portion of the case;
a heat radiating adhesive that fills a gap generated between the bottom surface portion of the case and the metal plate; and
a fastener that fixes the first fastening section and the second fastening section together.

2. The reactor apparatus according to claim 1, wherein:
the first and the second fastening sections respectively include circular holes having center positions that are identical to each other when the case is fastened to the metal plate; and
the fastener includes a screw hole along a central axis and is inserted in the hole of the first fastening section, the fastener being a metal collar integrally shaped with the first fastening section by molding, and fixing the first fastening section to the second fastening section by tightening a screw into the screw hole, the screw being inserted from the hole of the second fastening section.

3. The reactor apparatus according to claim 2, wherein:
the collar includes an upper end that protrudes from the hole of the first fastening section above an upper surface portion of the first fastening section; and
a gap generated between the protruding upper end of the collar and the upper surface portion of the first fastening section is filled with a heat radiating adhesive.

4. The reactor apparatus according to claim 2, wherein:
the first fastening section is formed of a leg-like shape protruding and extending from an outer edge of the bottom surface portion in parallel to a horizontal surface of the bottom surface portion of the case; and
the second fastening section is formed of a leg-like shape protruding and extending from an outer edge of the metal plate in parallel to a horizontal surface of the metal plate.

5. The reactor apparatus according to claim 1, wherein:
the coil is a toroidal-shaped coil; and
the case includes a center fixing member that is formed so as to protrude from a center portion of the bottom surface portion and that is fitted into a hole at a center portion of the coil to fix the coil at a center position inside the case.
